(19) United States
(12) Patent Application Publication
(10) Pub. No.: US 2004/0091134 A1
(43) Pub. Date: May 13, 2004

(54) Queuing management and vessel recognition

(75) Inventor: Michael P. Long, Rolling Hills Estates, CA (US)

Correspondence Address: MCDERMOTT, WILL & EMERY, Suite 3400, 2049 Century Park East, Los Angeles, CA, 90067, US

(73) Assignee: Premier Wireless, Inc.

(21) Appl. No.: 10/696,082

(22) Filed: Oct. 29, 2003

Related U.S. Application Data
(60) Provisional application No. 60/422,370, filed on Oct. 30, 2002.

(51) Int. Cl. G06K 9/00

(52) U.S. Cl. 382/104

(57) ABSTRACT

A queuing management system for managing a queue of waiting vessels or persons having a pass-through point may include a camera system configured to generate one or more images of the queue and sequential images of the pass-through point. It may include an image processing system configured to calculate information indicative of the anticipated delay in the queue, the rate of passage through the pass-through point, the number of vessels or persons in the queue, the number of vessels or persons that have passed through the pass-through point, the type of vessel, and/or unusual movement of a vessel or person in the queue, all based on the images from the camera system. Related processes are also disclosed.

### CROSS-REFERENCE TO RELATED APPLICATIONS

This application is based upon and claims priority to U.S. Provisional Application Serial No. 60/422,370, filed Oct. 30, 2002, entitled “Queuing Management and Targeting Vehicle Recognition System (QMVRS),” the entire content of which is incorporated herein by reference.

### BACKGROUND

Field

This disclosure relates to queuing management and vessel identification systems and methods.

Related Art

Queues and passageways through which vessels or persons pass often need to be analyzed.

For example, it is often important to analyze the flow of vehicles at a variety of locations, such as at border crossings, military bases, sporting and entertainment venues, parking complexes and traffic intersections.

The number of vehicles that pass through a passageway is one example of a type of information that may be desired.

It may also be desirable to know the rate at which the vehicles are passing through the passageway. When that passageway is being managed by an operator, such as at a border crossing, the rate at which vehicles pass may be useful in analyzing the performance of the operator. For example, if vehicles pass too quickly through a checkpoint, it may indicate that the operator is not spending enough time studying the vehicles before allowing them to pass. Conversely, if the rate of passage is too slow, it may indicate that the operator is spending too much or is not performing his job efficiently.

The rate at which vehicles pass a checkpoint may also be indicative of a dishonest operator. For example, border crossings often contain a number of lanes through which a vehicle may pass. Each lane may be managed by a separate operator. A dishonest operator who is willing to allow a vehicle through the checkpoint that should not be passed may deliberately pass several vehicles at an unusually high rate as a means of signaling a spotter, who then directs the smuggler to head for the lane managed by the dishonest operator.

The queue delay is another example of information that can be useful. The amount of time that it is likely to take to get through the queue can be used, for example, to determine the number of lanes that should be opened.

When multiple lanes are involved, the analysis may be performed individually on each lane or, in certain cases, on the entire set.

It may also be desirable to identify a particular type of vehicle that is waiting or passing through a queue. This can be helpful in connection with a law enforcement effort that is searching for a particular vehicle. It may also be helpful in connection with queues that only pass vehicles of certain types. A statistical analysis of the types of vehicles that pass through may also be helpful in designing the passageway areas.

### SUMMARY

A queuing management system for managing a queue of waiting vessels or persons having a pass-through point may include a camera system configured to generate one or more images of the queue and sequential images of the pass-through point. It may also include an image processing system configured to calculate information indicative of the anticipated delay in the queue based on the images from the camera system.

The image processing system may also be configured to calculate the rate at which vessels or persons pass through the pass-through point based on the images. The image processing system may also be configured to calculate the number of vessels or persons in the queue based on the images. The image processing system may also be configured to calculate the number of vessels or person in the queue by determining the length of the queue based on the images and by dividing this length by a number representative of the anticipated average length of the portion of the queue occupied by each vessel or person.

The image processing system may also be configured to calculate the delay in the queue by dividing the number of vessels or persons in the queue by the rate at which vessels or persons pass through the pass-through point.

The image processing system may also be configured to calculate information indicative of the anticipated delay of vehicles in the queue based on the images from the camera system.

A method of managing a queue of waiting vessels or persons having a pass-through point may include generating one or more images of the queue and sequential images of the pass-through point and calculating information indicative of the anticipated delay in the queue based on the images.

A passageway management system for managing a passageway through which vessels or persons pass may include a camera system configured to generate sequential images of the passageway and an image processing system configured to calculate information indicative of the rate at which the vessels or persons pass through the passageway based on the images from the camera system.

The image processing system may also be configured to also count the number of vessels or persons that pass through the passageway based on the images.

The image processing system may also be configured to calculate the information indicative of the rate by dividing the count of the number of vessels or persons that pass through the passageway over a period of time by the period of time.

The image processing system may also be configured to calculate information indicative of the rate at which vehicles pass through the passageway based on the images from the camera.

A method of managing a passageway through which vessels or persons pass may include generating sequential images of the passageway and calculating information indicative of the rate at which the vessels or persons pass through the passageway based on the images from the camera system.

A queuing management system for managing a queue of waiting vessels or persons having a pass-through point may include a camera system configured to generate one or more images of the queue and an image processing system configured to determine information indicative of the number of vessels or persons in the queue based on the image or images from the camera system.

The image processing system may also be configured to calculate the information indicative of the number of vessels or person in the queue by determining the length of the queue based on the image or images and by dividing this length by a number representative of the anticipated average length of the space in the queue occupied by each vessel or person.

The image processing system may also be configured to determine the length of the queue by determining where in at least one of the images the density of edges falls below a threshold.

The image processing system may also be configured to calculate information indicative of the number of vehicles in the queue based on the images from the camera system.

A method for managing a queue of waiting vessels or persons having a pass-through point may include generating one or more images of the queue and determining information indicative of the number of vessels or persons in the queue based on the image or images.

A passageway management system for managing a passageway through which vessels or persons pass may include a camera system configured to generate sequential images of the passageway and an image processing system configured to count the number of vessels or persons that pass through the passageway based on the images.

The image processing system may be configured to calculate the number of vehicles that pass through the passageway based on the images from the camera.

A method for managing a passageway through which vessels or persons pass may include generating sequential images of the passageway and counting the number of vessels or persons that pass through the passageway based on the images.

A passageway management system through which vessels pass may include a camera system configured to generate sequential images of the passageway and an image processing system configured to determine the type of each vessel that passes through the passageway based on the images from the camera system.

The image processing system may also be configured to determine the type of each vehicle that passes through the passageway.

The image processing system may also be configured to determine whether the type of each vehicle is a sedan, sport utility vehicle, minivan or pickup.

The image processing system may also be configured to distinguish between a sport utility vehicle and a minivan by comparing the slope of the windshield of the vehicle from the images from the camera system to a reference value.

The image processing system may also be configured to determine the color of each vehicle that passes through the passageway as part of the type determination.

The image processing system may also be configured to determine the type of each vehicle by extracting one or more features of the vehicle from an image of the vehicle and by comparing the extracted one or more features to a database that relates features to vehicle types.

The passageway management system may include a neural network configured to assist in determining the type of each vehicle that passes through the passageway.

The passageway management system may include a storage area configured to store information indicative of a particular vehicle type and an output device for communicating when a vehicle of the particular type has been detected by the image processing system.

A process for managing a passageway through which vessels pass may include generating sequential images of the passageway and determining the type of each vessel that passes through the passageway based on the images.

A queuing management system for managing a queue of waiting vessels or persons may include a camera system configured to generate sequential images of the queue, an image processing system configured to detect unusual movement of a vessel or person within the queue based on the images from the camera system, and an output device configured to communicate any unusual movement detected by the image processing system.

The image processing system may also be configured to detect a vehicle making a U-turn within the queue and wherein the output device is configured to communicate the detection of a U-turn by the image processing system.

The image processing system may also be configured to detect a vehicle making an abnormal lane change within the queue and wherein the output device is configured to communicate the detection of an abnormal lane change by the image processing system.

The image processing system may also be configured to detect a vehicle traveling at an abnormal speed within the queue and wherein the output device is configured to communicate the detection of abnormal speed by the image processing system.

A method for managing a queue of waiting vessels or persons may include generating sequential images of the queue, detecting unusual movement of a vessel or person within the queue based on the images, and communicating any unusual movement that is detected.

These, as well as still further features, objects, and benefits will now become clear upon a review of the detailed description of illustrative embodiments and accompanying drawings.

### BRIEF DESCRIPTION OF DRAWINGS

FIG. 1 is a block diagram of a queuing management and vessel identification system.

FIG. 2 illustrates a multi-lane queue of vehicles and a camera system that is monitoring this queue.

### DETAILED DESCRIPTION OF ILLUSTRATIVE EMBODIMENTS

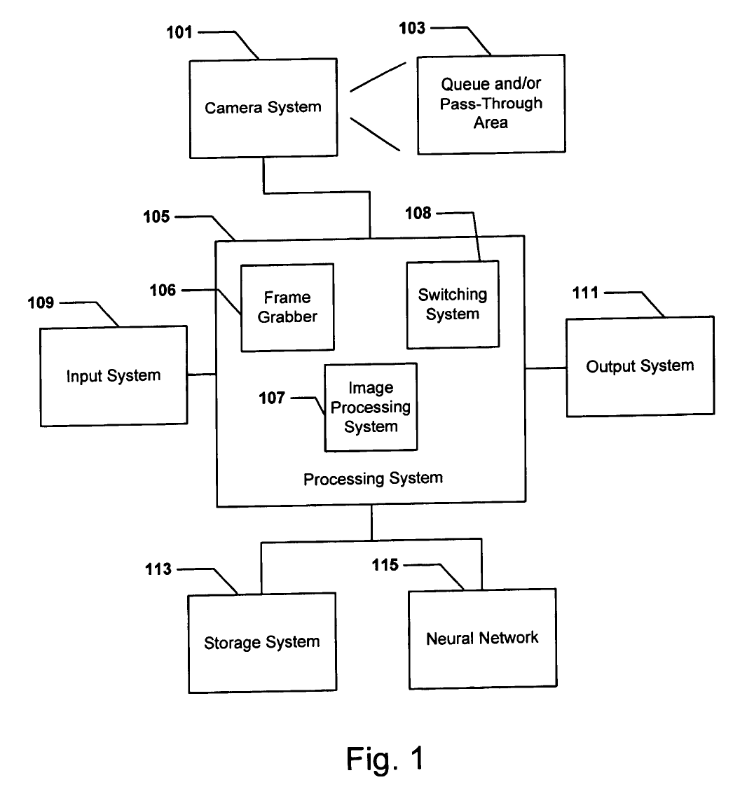

FIG. 1 is a block diagram of a queuing management and vessel identification system.

As shown in FIG. 1, a camera system 101 may create images of a queue and/or pass-through area 103.

The images from the camera system 101 may be delivered to and may be controlled by a processing system 105, which may include an imaging processing system 107, A frame grabber 106 and a switching system 108. An input system 109 may be used to control the operation of the processing system 105. An output system 111 may be used to communicate information from the processing system 105. A storage system 113 may be used to store relevant information, and a neural network 115 may be used to assist in connection with certain types of image processing.

The queue and/or pass-through area 103 may include any type of queue, including a queue of vessels, such as a queue of vehicles, ships or planes, or a queue of persons.

A pass-through area may be included with the queue or may be without the queue. The pass-through area may be an area through which the passage of a person or vessel is regulated, such as a border crossing, military base, sporting or entertainment venue, parking complex, traffic intersection, shipping dock or airport runway. The queue and/or pass-through area may consist of a single lane or multiple lanes. In the case of multiple lanes, the multiple lanes may be serviced by a single pass-through area or by multiple pass-through areas, including a separate pass-through area for each single lane.

The camera system 101 may be positioned so as to generate images of the queue and/or pass-through area 103.

The camera system 101 may include one or more cameras, such as video cameras or infrared cameras. The exact number may depend upon the particular type of information that is desired, as will become more apparent in the discussion below.

The camera system 101 may include fixed cameras and/or cameras that can pan, tilt and/or zoom pursuant to an external control. The external control may include one or more signals sent from the processing system 105.

For example, a single camera may be used to monitor both a queue and a pass-through point of the queue. The single camera may be positioned so as to be able to monitor all of this activity within a single frame of view. Alternatively, the single camera may include a panned, tilt and/or zoom control that allows the camera to view different aspects of this area at different points in time, all under the control of the processing system 105.

A multiple camera embodiment may be useful in those situations where higher resolution or frame speed is helpful. Even in a multiple camera embodiment, however, one or more of the cameras may still include a pan, tilt and/or zoom feature, again operable under the control of the processing system 105.

In one embodiment, for example, a single camera may be used to provide images that will enable the processing system to determine the end of a queue. The processing system may function best when the image of the vehicle or person at the end of the queue always occupies approximately the same amount of space in about the center of the image frame. On the other hand, variations in the length of the queue may cause the distance between the camera and the end of the queue to vary, as well as the direction in which the camera must be pointed to view the end of the queue. Under appropriate control of the processing system 105, the camera may be directed to change its direction and zoom so as to always cause the end of the queue to appear approximately in the middle of the frame and to occupy approximately the same portion of the frame.

The exact locations at which the cameras in the camera system 101 may be positioned may also vary widely, again depending upon the desired application. In some situations, for example, one or more of the cameras in the camera system 101 may be positioned directly to the side of a pass-through point so as to always view a clear profile of the vessels or persons that are passing through this pass-through point. One or more other cameras may be positioned to focus on the anticipated area where the queue will appear, including its end. If there are multiple lanes, there may be separate cameras to perform each of these functions for each of the lanes. Alternatively, one or more cameras may take broad panoramic views of the lanes or, under the control of the processing system 105, be directed to pan, tilt and zoom as necessary to focus at different times on just one of the lanes.

The cameras in the camera system 101 may be mounted at their ground level, at approximately the middle of the height of the anticipated vessels or persons, several feet above the top of the anticipated vessels or persons, or at any other level. Again, the exact placement may depend upon the particular application and information that is desired.

The processing system 105 may be implemented with a general purpose computer (e.g., a PC or a Mac), a computer dedicated to queuing management or vessel recognition, a stand-alone computer, a network of computers, a computer connected to a network, any other type of system, or a mixture of any of these types.

The processing system may be configured with appropriate hardware and/or software to implement the functions discussed herein in accordance with well known techniques.

The processing system 105 may include an image processing system 107. The image processing system 107 may be a subsystem of all or a portion of the processing system 105 or may be separate from it. The image processing system 107 may include hardware, software, or a combination of hardware and software.

One function of the image processing system 107 may be to receive one or more images from the camera system 101 and to process those images to extract information of the type needed to perform one or more desired operations, which may include one or more of the operations described below. The image processing system 107 may process an image consisting of a single frame from the camera system 101, an image consisting of a partial frame from the camera system 101, an image consisting of multiple frames from the camera system 101, and/or an image consisting of multiple partial frames from the camera system 101. The image processing system 107 may process several images from the camera system 101 at the same time or at different times.

The image processing system 107 may utilize known pattern and image recognition techniques in order to extract the information that is desired. It may process images of multiple lanes, either one at a time or several at the same time.

The information developed by the information processing system 107 may be used by the processing system 105 to control the pan, tilt and/or zoom of one or more cameras that form a part of the camera system 101 in order to obtain one or more further images.

The image processing system 107 may include a frame grabber 106. This device may receive live feeds from one or more cameras and capture frames from the live feeds at a sampling rate, on command, based on the content of earlier frames or other information, and/or based on a combination of these approaches. The frame grabber 107 may process multiple frames from multiple cameras at the same time or only a single frame at a time. In the event that the frame grabber processes only a single frame at a time, but needs to be connected to multiple cameras, a switching system may be employed to select the camera whose output will be processed by the frame grabber. The switching system may operate automatically under the control of the processing system 105. The frame grabber 107 may be part of the processing system 105, such as a plug in board for a PC, or may be separate from it.

The storage system 113 may include one or more storage devices, such as hard disk drives, non-volatile memory, volatile memory, CDs, DVDs and/or tapes. The storage system 113 may be configured in conjunction with the processing system 105 to store various kinds of information, including video information coming from the camera system 101, processed images coming from the image processing system 107, one or more of the calculations that are made by the image processing system 107 (as discussed in more detail below), and/or a time stamp correlated to the time when each piece of information has been received and/or stored. The storage system 113 may also store records concerning input that has been provided to the processing system by the input system 109 and/or output that has been delivered to the output system 111. The information that is stored within the storage system 113 may be updated periodically, on command, and/or based on the content of the images provided by the camera system 101.

The input system 109 may include any type of input device, such as a keyboard, mouse and/or touch screen. The input system 109 may also include a communication link, such as a communication link to a network.

The output system 111 may include any type of output device, such as a display, audio device (including an alarm) and/or printer. The output system 111 may also include a communication link, such as a communication link to a network. Information may be delivered to the output system on a periodic basis, on demand, in response to input from the input system and/or in response to information from the camera system 101. For example, selected images from the camera system 101 may be displayed on the output system 111, along with information relating to computations or analysis of the images from the camera system 101 performed by the image processing system 107, such as one or more of the types of information that will be discussed below.

The processing system 105 may be configured to receive information from the input system 109 relating to the functions, the output and the storage that the processing system 105 manages. Similarly, the processing system 105 may be configured to deliver information to the output system relating to the functions, storage and/or input that it receives.

A neural network 115 may be included. In conjunction with the processing system 105, the neural network 115 may manage or assist in connection with the work done by the image processing system 107, as described in more detail below in connection with one embodiment.

The queuing management and vessel identification system shown in FIG. 1 and described above may be configured and operated to effectuate a broad variety of queuing management and/or vessel identification functions and operations.

For example, the system shown in FIG. 1 may be configured to count the number of vessels or persons that pass through a pass-through point, such as the number of vehicles that pass through a customs check station. In this embodiment, the camera system 101 may include one or more cameras focused on the pass-through point. Images from the camera system 101 may be processed by the image processing system 107 to increment a count maintained in the processing system 105, each time a vehicle passes through.

Many types of well-known techniques may be used in connection with the image processing system 107 to discern the passage of each vehicle. One such technique, for example, may be to examine an area on each image frame that comes from the camera system 101 and to determine the density of edges in that portion of the frame. If the edge density is high, this may indicate the presence of a vehicle within that area and be accepted as such. If the edge density is low, on the other hand, this may indicate the absence of a vehicle within that area and be accepted as such. The edge density, in turn, may be indicated by rapid grayscale changes in the image.

Other techniques may also be used. For example, a special color may be placed on the other side of the vehicle, such that the vehicle blocks a camera's view of the special color when passing through the pass-through point.

A still further approach may be to analyze the presence or absence of motion in a series of successive frames. Other image recognition techniques may also be used.

The image processing system 107 may also be used to compute that rate at which vessels or persons pass through a particular pass-through point. In this embodiment, the image processing system 107 may count the vessels or persons that pass through a particular pass-through point during a particular time period and divide that count by that particular time period.

The image processing system 107 may also be used to determine the number of vessels or persons that pass through a particular pass-through point over a long period of time, such as the shift of an operator stationed at that pass-through point. The image processing system 107 may compute this number by simply counting the number of vessels or persons that pass through the pass-through point during the shift or other desired time segment.

The image processing system 107 may also be used to compute the length of the queue of vessels or persons that may be waiting to pass through a particular pass-through point or a set of pass-through points. A broad variety of processing techniques may be employed to accomplish this.

For example, the camera system 101 may include a camera that creates an image of the entire queue, from beginning to end. The image processing system 107 may determine the length of the queue from this image. The image processing system 107 may next divide the determined length of the entire queue by a previously determined number that represents the average space in the queue occupied by each vessel or person. The result may be a number representing the number of vehicles or persons in the queue.

The determination of the number of vessels or persons in the queue may also be performed using an appropriate image-recognition technique that distinguishes each vehicle and thus allows each distinguished vehicle to be counted.

Instead of having a single camera focusing on the entire queue in the camera system 101, the camera system may include a plurality of cameras directed to different portions of the queue or a single camera that acquires images of the different portions of the queue at different times, under the tilt, pan or zoom control of the processing system 105. In this situation, the image processing system 107 may examine more than a single image in making the queue count determination.

The image processing system 107 may also compute a queue delay time from the images, i.e., an estimate of the amount of time that a vessel or person will need to wait before being able to pass through the queue. This determination may be based on the determination of the number of persons or vessels in the queue, divided by the flow rate at the pass-through point. These subsidiary determinations may be made in accordance with the procedures discussed above or in accordance with other procedures.

The image processing system 107 may also be used to process the images from the camera system 101 for the purpose of identifying the type of vessels that passes through a pass-through point, are present in the queue, or are at some other location.

To accomplish this, the image processing system 107 may operate in conjunction with the frame grabber 106 and the camera system 101 to capture an image of each vessel from a perspective that may correspond with a library of image types that are stored in the storage system 113. For example, the image processing system 107 in conjunction with the frame grabber 105 and the camera system 101 may capture an image of the side profile of a vehicle. The image processing system 107 may develop a projection of that image and compare it with known projections that are stored in the storage system 113 for the purpose of determining the type of vehicle that is being examined.

Vehicle typing may be performed at different levels. For example, an effort may be made by the image processing system to identify the exact make and model of each vehicle. Alternatively, or in addition, the image processing system 107 in conjunction with the profiles stored in the storage system 113 may be configured to merely determine whether the vehicle is a sedan, a sport utility vehicle, a minivan or a pickup. In distinguishing between a sport utility vehicle and a minivan, the image processing system 107 may focus on the slope of the windshield in the projection and may classify the vehicle as a sport utility vehicle if the slope is shallow or as a minivan if the slope is steep. Of course, vehicle classifications may be based on factors other than or in addition to projections, including unique ornaments, trim or other distinctive features.

The image processing system 107 may also make use of the neural network 115 in typing the vessels that pass through the pass-through area. This may be performed in accordance with well known neural network image processing techniques during which the processing is preceded by one or more training sessions to enhance the accuracy of the image recognition.

A broad variety of techniques may be used to determine which frame from the camera system 101 should be analyzed for the purpose of typing a vessel. In one embodiment, movement recognition or edge density technology may be used to select the frame in which the vehicle lies in its approximate center.

A broad variety of uses may be made of the vessel typing that may be performed by the image processing system 107. For example, a specified type of vehicle may be entered into the storage system 113 from the input system 109 through the processing system 105. The vessel types identified by the image processing system 107 may then be compared to the specified type. If and when a match is found, information or and/or about that match may be sent by the processing system 105 to the output system 111, such as to display an alert on a display, to send a communication to the operator of the pass-through point at which the specified vehicle was detected, and/or to sound an alarm.

The flow rate that may be calculated by the image processing system 107 may be compared to a previously stored minimum or maximum rate. Any detected rate that falls outside of this range may similarly trigger a communication to the output system 111. For an example, a rate that is too fast may trigger an alarm at a border entry, warning that a pass through operator may be signaling his willingness to permit an unauthorized pass-through by speeding the pace of his inspections.

The vessel recognition function of the image processing system 107 may also determine the color of the vessel as part of the vessel typing. When a search for a particular type of vehicle is desired, information about both the projection and color of the vehicle may accordingly be stored in the storage system 113 and compared with the corresponding information extracted by the image processing system 107.

The image processing system 107 may also be configured to detect unusual movement of a vessel or person. For example, the image processing system 107 may be configured to detect a U-turn being made by a vehicle, a change to a longer lane, or unusual speed. Again, appropriate and well known image and pattern recognition techniques may be used.

The image processing system 107 may also be configured to extract identifying information on a vessel or person, such as the license plate of a vehicle. Of course, the camera system 101 may include a camera that is directed to such information and appropriate pattern recognition technology in the image processing system 107.

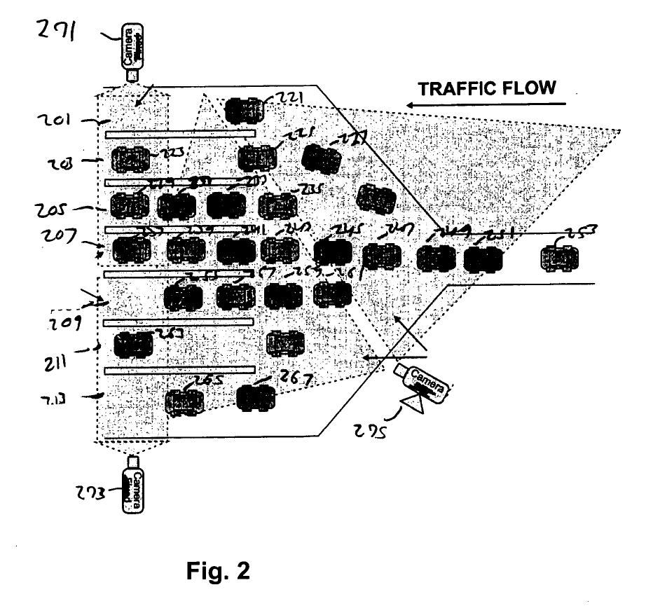

FIG. 2 illustrates a multi-lane queue of vehicles and a camera system that is monitoring this queue.

As shown in FIG. 2, a multi-lane queue may include lanes 201, 203, 205, 207, 209,211 and 213. Within each lane may be one or more vehicles, such as a vehicle 221 in lane 201, vehicles 223, 225 and 227 in lane 203, vehicles 229, 231, 233 and 235 in lane 205, vehicles 237, 239, 241, 243, 245, 247, 249 and 251 in lane 207, vehicles 255, 257, 259 and 261 in lane 209, a vehicle 263 in lane 211 and vehicles 265 and 267 in lane 213.

The camera system may include a camera 271 focused on the pass-through points of the lanes 201, 203, 205 and 207; a camera 273 focused on the pass-through points of the lanes 209, 211 and 213, and a camera 275 focused on another portion of the queue.

The pan, tilt and zoom of the cameras 271 and 273 may be controlled to cause these cameras to focus upon only a single pass-through point at a time. Alternatively, the cameras 271 and 273 may focus on several pass-through points, leaving it to the image processing system 107 to separate out the movement within each lane.

Similarly, the camera 275 may be focused on the entire queue or on only a portion of the queue at a single point in time. If it is focused on only a portion of the queue, its pan, tilt and zoom may be controlled by the processing system 105 to cause it to be directed to different portions of the queue so as to provide in totality the necessary image information.

The cameras 271, 273 and 275 may be located several feet above the top of the vehicles so as to enable them to capture an image of a vehicle that is separated from the camera by one or more intervening vehicles. In addition or instead, a separate camera may be provided for each lane of the queue.

The features, components, steps, attributes and benefits that are discussed above are merely examples. Protection is limited solely to the claims that now follow and to their equivalents.

We claim:

1. A queuing management system for managing a queue of waiting vessels or persons having a pass-through point comprising:
a camera system configured to generate one or more images of the queue and sequential images of the pass-through point; and
an image processing system configured to calculate information indicative of the anticipated delay in the queue based on the images from the camera system.

2. The queuing management system of claim 1 wherein the image processing system is configured to also calculate the rate at which vessels or persons pass through the pass-through point based on the images.

3. The queuing management system of claim 2 wherein the image processing system is configured to also calculate the number of vessels or persons in the queue based on the images.

4. The queuing management system of claim 3 wherein the image processing system is configured to calculate the number of vessels or person in the queue by determining the length of the queue based on the images and by dividing this length by a number representative of the anticipated average length of the portion of the queue occupied by each vessel or person.

5. The queuing management system of claim 3 wherein the image processing system is configured to also calculate the delay in the queue by dividing the number of vessels or persons in the queue by the rate at which vessels or persons pass through the pass-through point.

6. The queuing management system of claim 1 wherein the image processing system is configured to calculate information indicative of the anticipated delay of vehicles in the queue based on the images from the camera system.

7. A method of managing a queue of waiting vessels or persons having a pass-through point comprising:
generating one or more images of the queue and sequential images of the pass-through point; and
calculating information indicative of the anticipated delay in the queue based on the images.

8. A passageway management system for managing a passageway through which vessels or persons pass comprising:
a camera system configured to generate sequential images of the passageway; and
an image processing system configured to calculate information indicative of the rate at which the vessels or persons pass through the passageway based on the images from the camera system.

9. The passageway management system of claim 8 wherein the image processing system is configured to also count the number of vessels or persons that pass through the passageway based on the images.

10. The passageway management system of claim 9 wherein the image processing system is configured to calculate the information indicative of the rate by dividing the count of the number of vessels or persons that pass through the passageway over a period of time by the period of time.

11. The passageway management system of claim 8 wherein the image processing system is configured to calculate information indicative of the rate at which vehicles pass through the passageway based on the images from the camera.

12. A method of managing a passageway through which vessels or persons pass comprising:
generating sequential images of the passageway; and
calculating information indicative of the rate at which the vessels or persons pass through the passageway based on the images from the camera system.

13. A queuing management system for managing a queue of waiting vessels or persons having a pass-through point:
a camera system configured to generate one or more images of the queue; and
an image processing system configured to determine information indicative of the number of vessels or persons in the queue based on the image or images from the camera system.

14. The queuing management system of claim 13 wherein the image processing system is configured to calculate the information indicative of the number of vessels or person in the queue by determining the length of the queue based on the image or images and by dividing this length by a number representative of the anticipated average length of the space in the queue occupied by each vessel or person.

15. The queuing management system of claim 14 wherein the image processing system is configured to determine the length of the queue by determining where in at least one of the images the density of edges falls below a threshold.

16. The queuing management system of claim 13 wherein the image processing system is configured to calculate information indicative of the number of vehicles in the queue based on the images from the camera system.

17. A method for managing a queue of waiting vessels or persons having a pass-through point:
generating one or more images of the queue; and
determining information indicative of the number of vessels or persons in the queue based on the image or images.

18. A passageway management system for managing a passageway through which vessels or persons pass comprising:
a camera system configured to generate sequential images of the passageway; and
an image processing system configured to count the number of vessels or persons that pass through the passageway based on the images.

19. The passageway management system of claim 18 wherein the image processing system is configured to calculate the number of vehicles that pass through the passageway based on the images from the camera.

20. A method for managing a passageway through which vessels or persons pass comprising:
generating sequential images of the passageway; and
counting the number of vessels or persons that pass through the passageway based on the images.

21. A passageway management system through which vessels pass comprising:
a camera system configured to generate sequential images of the passageway; and
an image processing system configured to determine the type of each vessel that passes through the passageway based on the images from the camera system.

22. The passageway management system of claim 21 wherein the image processing system is configured to determine the type of each vehicle that passes through the passageway.

23. The passageway management system of claim 22 wherein the image processing system is configured to determine whether the type of each vehicle is a sedan, sport utility vehicle, minivan or pickup.

24. The passageway management system of claim 23 wherein the image processing system is configured to distinguish between a sport utility vehicle and a minivan by comparing the slope of the windshield of the vehicle from the images from the camera system to a reference value.

25. The passageway management system of claim 22 wherein the image processing system is configured to determine the color of each vehicle that passes through the passageway as part of the type determination.

26. The passageway management system of claim 22 wherein the image processing system is configured to determine the type of each vehicle by extracting one or more features of the vehicle from an image of the vehicle and by comparing the extracted one or more features to a database that relates features to vehicle types.

27. The passageway management system of claim 22 further including a neural network configured to assist in determining the type of each vehicle that passes through the passageway.

28. The passageway management system of claim 21 further including a storage area configured to store information indicative of a particular vehicle type and an output device for communicating when a vehicle of the particular type has been detected by the image processing system.

29. A process for managing a passageway through which vessels pass comprising:
generating sequential images of the passageway; and
determining the type of each vessel that passes through the passageway based on the images.

30. A queuing management system for managing a queue of waiting vessels or persons comprising:
a camera system configured to generate sequential images of the queue;
an image processing system configured to detect unusual movement of a vessel or person within the queue based on the images from the camera system; and
an output device configured to communicate any unusual movement detected by the image processing system.

31. The queuing management system of claim 30 wherein the image processing system is configured to detect a vehicle making a U-turn within the queue and wherein the output device is configured to communicate the detection of a U-turn by the image processing system.

32. The queuing management system of claim 30 wherein the image processing system is configured to detect a vehicle making an abnormal lane change within the queue and wherein the output device is configured to communicate the detection of an abnormal lane change by the image processing system.

33. The queuing management system of claim 30 wherein the image processing system is configured to detect a vehicle traveling at an abnormal speed within the queue and wherein the output device is configured to communicate the detection of abnormal speed by the image processing system.

34. A method for managing a queue of waiting vessels or persons comprising:
generating sequential images of the queue;
detecting unusual movement of a vessel or person within the queue based on the images; and
communicating any unusual movement that is detected.
